(19) United States
(12) Patent Application Publication
(10) Pub. No.: US 2008/0110490 A1
(43) Pub. Date: May 15, 2008

(54) PHOTOVOLTAIC CONNECTION SYSTEM

(75) Inventor: Scott Stephen DUESTERHOEFT, Etters, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Middletown, PA (US)

(21) Appl. No.: 11/559,979

(22) Filed: Nov. 15, 2006

(51) Int. Cl. H02N 6/00

(52) U.S. Cl. 136/248

(57) ABSTRACT

A photovoltaic connection system and junction box for maximum current output and heat dissipation properties. The junction box includes a box portion, heat dissipating portion and a printed circuit board (PCB). The PCB includes at least one heat emitting electrical components, each heat emitting electrical component having a heat sink element attached thereto for dissipating heat generated by the heat emitting electrical component. The junction box further includes at least one electrical contact electrically connected to the at least one heat emitting electrical component. The box portion is configured for receiving at least a portion of the PCB and having an opening disposed for receiving external power input wiring by electrical contact with the at least one electrical contact. The heat dissipating portion being made of a thermally conductive material covering at least a portion of the heat sink.

### FIELD OF THE INVENTION

The present invention is directed to a connection system for photovoltaic (PV) arrays, and more particularly to a connection box in a PV connection system with improved thermal transfer properties for higher current carrying capacity.

### BACKGROUND OF THE INVENTION

Photovoltaic (PV) modules or arrays produce electricity from solar energy. Electrical power produced by PV modules reduces the amount of energy required from non-renewable resources such as fossil fuels and nuclear energy. Significant environmental benefits are also realized from solar energy production, for example, reduction in air pollution from burning fossil fuels, reduction in water and land use from power generation plants, and reduction in the storage of waste byproducts. Solar energy produces no noise, and has few moving components. Because of their reliability, PV modules also reduce the cost of residential and commercial power to consumers.

PV cells are essentially large-area semiconductor diodes. Due to the photovoltaic effect, the energy of photons is converted into electrical power within a PV cell when the PV cell is irradiated by a light source such as sunlight. PV cells are typically interconnected into solar modules that have power ranges of up to 100 watts or greater. For large PV systems, special PV modules are produced with a typical power range of up to several 100 W. A photovoltaic module is the basic element of a photovoltaic power generation system. A PV module has many solar cells interconnected in series or parallel, according to the desired voltage and current parameters. PV cells are connected and placed between a polyvinyl plate on the bottom and a tempered glass on the top. PV cells are interconnected with thin contacts on the upper side of the semiconductor material. The amount of power generated by typical crystalline modules power ranges from several W to up to 150 W/module.

In the case of facade or roof systems, the photovoltaic system may be installed during construction, or added to the building after the building has been constructed. Roof systems are generally lower powered systems, e.g., 10 kW, to meet typical residential loads. Roof integrated photovoltaic systems may consist of different module types, such as crystalline and micro-perforated amorphous modules. Roof-integrated photovoltaic systems may be integrated into the roof such that the entire roof or a portion thereof is covered with photovoltaic modules, or the systems are added to the roof after roof construction has been completed. PV cells may be integrated with roof tiles.

PV modules/arrays require specially designed devices adapted for interconnecting the various PV modules/arrays with each other, and with electrical power distribution systems. PV connection systems are used to accommodate serial and parallel connection of PV arrays. In addition to connection boxes, a PV connection system includes connectors that allow for speedy field installation or high-speed manufacture of made-to-length cable assemblies. Connections or connection boxes may be required to receive specialized cable terminations from PV modules/arrays, with power diodes inside for controlling current flow to the load. Thus, certain connection box configurations may generate internal heat, which must be dissipated in order to protect the internal components and external structures adjacent to the connection box. In many cases, governmental regulations and industry standards establish a maximum permissible temperature that can be attained.

Therefore, there is a need for an improved connection box for dissipating heat expelled from electrical/electronic components inside of the box.

### SUMMARY OF THE INVENTION

A first aspect of the present invention includes a junction box for a photovoltaic system for maximum current output and heat dissipation properties. The junction box includes a box portion, heat dissipating portion and a printed circuit board (PCB). The PCB includes at least one heat emitting electrical component, each heat emitting electrical component having a heat sink element attached thereto for dissipating heat generated by the heat emitting electrical component. In the embodiment wherein the heat emitting electrical component is a diode, heat is generated by the restriction of the flow of electricity to one direction. The junction box further includes at least one electrical contact electrically connected to at least one heat emitting electrical component. The box portion is configured for receiving at least a portion of the PCB and having an opening disposed for receiving external power input wiring by electrical contact with at least one electrical contact. The heat dissipating portion is made of a thermally conductive material covering at least a portion of the heat sink.

Another aspect of the present invention includes a photovoltaic connection system and junction box for maximum current output and heat dissipation properties. The system includes a current providing device in electrical communication with a junction box. The junction box includes a box portion, heat dissipating portion and a printed circuit board (PCB). The PCB includes at least one heat emitting electrical component, each heat emitting electrical component having a heat sink element attached thereto for dissipating heat generated by the heat emitting electrical component. The junction box further includes at least one electrical contact electrically connected to at least one heat emitting electrical component. The box portion is configured for receiving at least a portion of the PCB and having an opening disposed that receives external power input wiring by electrical contact with at least one electrical contact. The heat dissipating portion is made of a thermally conductive material covering at least a portion of the heat sink.

An advantage of an embodiment of the present invention is improved heat dissipation from the components within the junction box.

Another advantage of an embodiment of the present invention is that a plurality of PV components may be connected to a single junction box.

Still another advantage of an embodiment of the present invention is that additional components, components having increased heat emission and/or PV components having increased current capacity may be utilized within the junction box.

Still another advantage of an embodiment of the present invention is that the system is easily fabricated and allows additional environmental protection for the electrical components present in the junction.

Still another advantage of an embodiment of the present invention is that the system of the present invention may utilized cooling system, such as liquid (e.g., water) cooled heat exchangers.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a top perspective view of a junction box according to an embodiment of the present invention.

FIG. 2A shows a perspective top view of a printed circuit board and circuitry according to an embodiment of the present invention.

FIG. 2B shows a perspective bottom view of a printed circuit board and circuitry according to an embodiment of the present invention.

FIG. 3 shows a top perspective view of a junction box according to an alternate embodiment of the present invention.

FIG. 4 shows a cutaway cross-sectional view of a junction box according to the embodiment of FIG. 3 of the present invention.

FIG. 5 shows a top perspective view of a junction box according to an alternate embodiment of the present invention.

Wherever possible, the same reference numbers are used throughout the drawings to refer to the same or like parts.

### DETAILED DESCRIPTION OF THE INVENTION

The present invention is directed to a junction box for interconnection of solar cell arrays having heat dissipation structures for dissipating heat emitted from electrical components. The heat dissipation structures conduct the heat from inside the junction box and emits the heat to the surrounding environment.

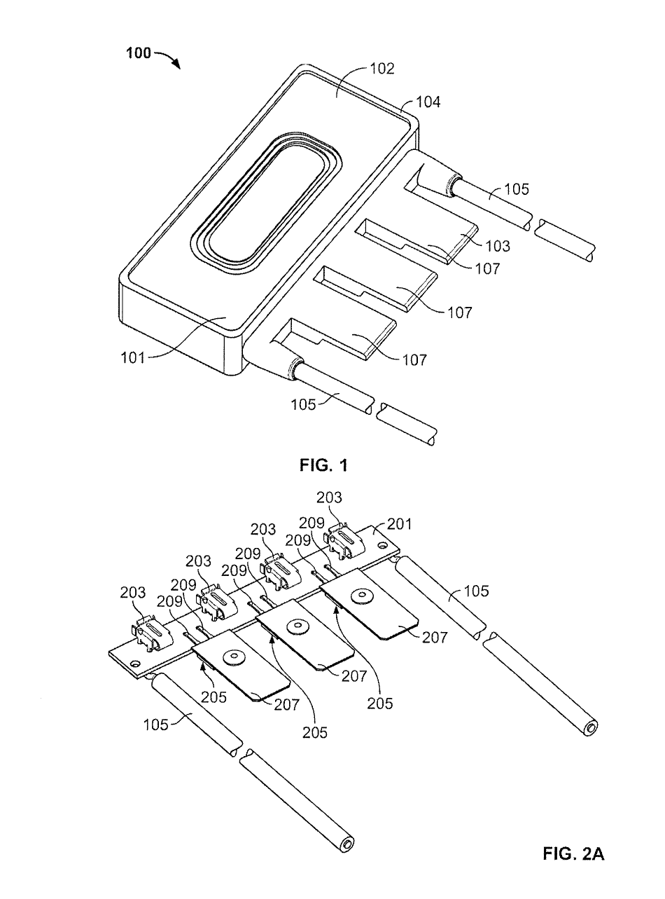

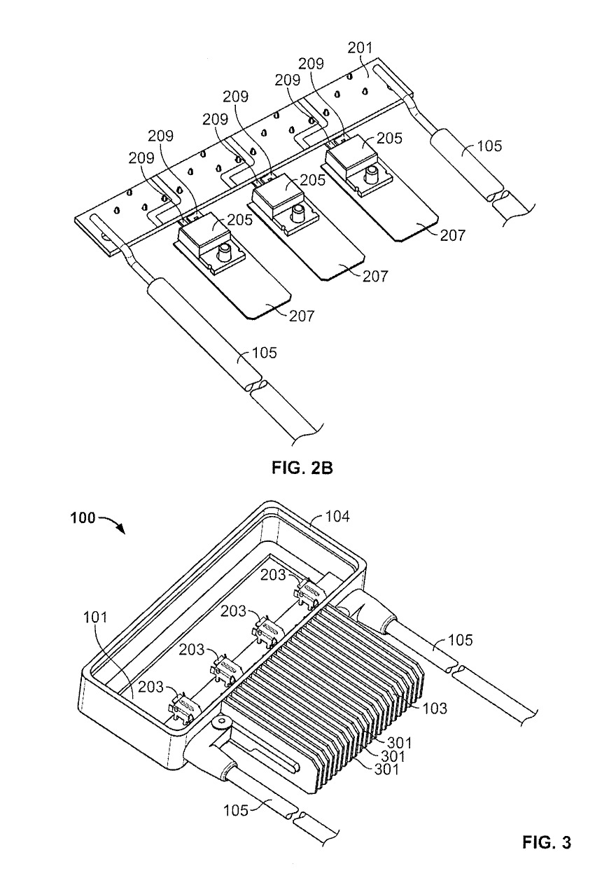

FIG. 1 includes junction box 100 according to an embodiment of the present invention. Junction box 100 includes a box portion 101 and a heat dissipating portion 103. Box portion 101 includes a cover 102 and non-electrically conductive case 104. The junction box 100 and associated cover portion 102 can be constructed of a substantially rigid, electrically insulating material suitable to receive the printed circuit board 201 (see e.g., FIG. 2), such as an ABS plastic or other suitable material. The junction box 100, cover 102 and case 104 preferably has enhanced thermal conductivity. The junction box 100 further includes wire leads 105. Wire leads 105 may be any wire, such as PV-type wire, cable or other electrically conductive device that allows electrical power to be brought to or from the junction box 100. Heat dissipating portion 103 further includes fins 107 that are preferably fabricated from a thermally conductive material, such as a polymeric or other non-electrically conductive thermally conductive material. Fins 107 may be arranged in any suitable manner that provides surface area available to the atmosphere for dissipation of heat. Fins 107 provide an electrical insulation barrier between 207 and 303. Thermally conductive grease or gel may be applied between 107 and 303 to improve thermal transfer rate.

FIGS. 2A and 2B show a junction box 100 according to an embodiment of the present invention with the cover 102 and the case 104 removed. FIG. 2A shows a perspective top view of the printed circuit board (PCB) 201 and FIG. 2B shows a perspective bottom view of the PCB 201. Referring to FIGS. 2A and 2B, wire leads 105 are attached to a PCB 201. The PCB 201 includes a number of spring clips or contacts 203 and heat emitting electrical devices 205, such as diodes, mounted thereon. The contacts 203 are preferably spring clips that secured to the PCB 201 with a solder connection to receive external power input wiring (not shown), such as wiring from a solar cell or solar circuitry. The contacts 203 may be arranged in any suitable manner that permits the connection of power input wiring. In addition, the heat emitting electrical devices 205 include a heat sink 207 in contact with the heat emitting electrical device 205. The heat sink 207 may be any thermally conductive material, which may or may not be electrically conductive, that is capable of transporting thermal energy (i.e., heat) away from the heat emitting electrical device 205. Any number of heat emitting electrical devices 205 and/or contacts 203 may be mounted on the PCB 201 and depends on the desired functionality and/or the size of the junction box 100. For example, a junction box 100 with two positions for connecting external input circuitry would have a PCB 201 with two contacts 203 mounted thereon. One embodiment of the present invention includes a PCB 201 having diode heat emitting electrical devices 205 with integral heat sinks 207 as part of the cathodes to help dissipate heat within the junction box 100. The PCB 201 may be mounted in junction box 100 in any suitable manner including, but not limited to, insertion of mounting posts, overmolding the PCB 201 or a portion thereof with casing material, or applying adhesives or other adherents to the PCB 201 and/or the case 104.

The heat emitting electrical device 205 for use with the present invention may include TO-220 packaged diodes. The TO-220 packaged diodes preferably contain heat sinks 207, such as heat sinks 207 fabricated from copper, that assist with dissipating heat and help to meet the temperature standard of IEC 61215 Edition 2 or other suitable industry standard or specification. The present invention may also use ITO-220AC diodes that have plastic covered heat sinks 207 and help to dissipate any generated heat to meet the IEC 61215 Edition 2. In addition to the TO-220 diode and ITO-220AC diode, any other similar and suitable diode that can meet the IEC 61215 Edition 2 standard may be used with the present invention.

As previously indicated, the junction box 100 has a pair of leads 105 for conducting power to or from connected solar cell array or circuitry (not shown). The leads 105 are attached to the PCB 201 in a conventional manner, such as solder or solderless connections. The connection of the leads 105 to the PCB 201 may be configured for bayonet-type locking engagement, threaded engagement, or any other connections known in the art. Polarization may be incorporated into the leads 105 and/or contacts 203 to ensure proper polarity of the external connections with the PCB 201.

An aperture may be provided on one side of case 104 to allow connections for incoming power conductors from the solar cell array (not shown). This aperture is typically oriented against a flat surface, such as a rooftop or rooftop-mounted array, which is sealed to the outside elements around the periphery of the case 104 and the aperture to provide environmental protection. The present invention is not limited to embodiments including apertures and may include covers, hinged openings or any other suitable structure that permits access to contacts 203.

In one embodiment, as shown in FIG. 2A, four contacts 203 are arranged across one edge of the PCB 201. The contacts 203 are spring clips preferably secured to the PCB 201 with a solderless connection. Heat emitting electrical devices 205 are attached to the PCB 201 by wire connections 209 adjacent to the contacts 203, preferably on an opposite surface of the PCB 201. Wire connections 209 may be leads, printed circuits, wires, solder, solderless, combinations thereof or any other electrical connection between the contacts 203 and the heat emitting electrical devices 205. The wiring between the contacts 203 and the heat emitting electrical devices 205 may be any suitable wiring configuration that connects power inputs to leads 105 and may include additional electrical devices known in the art to provide desired circuit functionality. The heat emitting electrical devices 205 are fastened to heat sinks 207 and are in thermal communication therewith. The heat sinks 207 may be constructed of copper, aluminum, or other thermally conductive material. Heat is conducted from the PCB 201 components including contacts 203 and heat emitting electrical devices 205, and other electrical and electronic components to the heat dissipating portion 103 through heat sinks 207. Heat dissipating portion 103 dissipates the heat from the heat sink 207 to the external environment.

FIG. 3 shows an alternate embodiment of the present invention, including a box portion 101 and a heat dissipating portion 103 with the cover portion 102 removed. The PCB 201, contacts 203, heat emitting electrical devices 205, wire connections 209, fins 107, case 104 and leads 105 are configured substantially as shown and described with respect to FIGS. 1 and 2, above. However, FIG. 3 further includes secondary fins 301 arranged in the heat dissipating portion 103 of junction box 100.

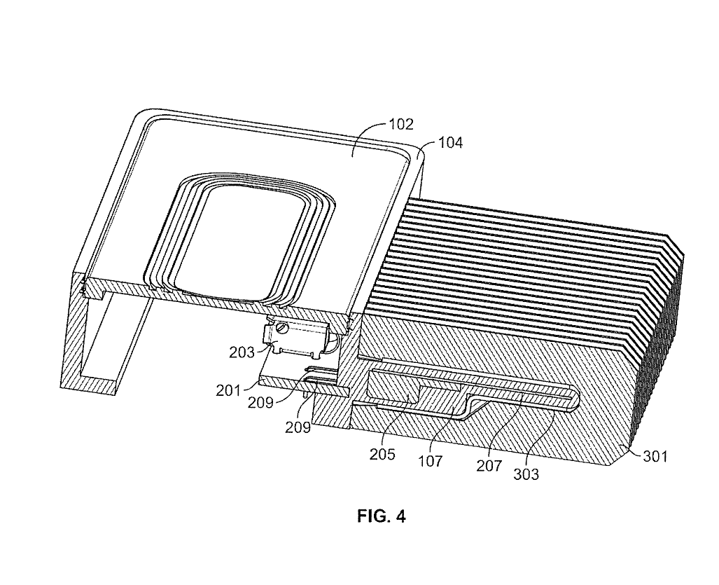

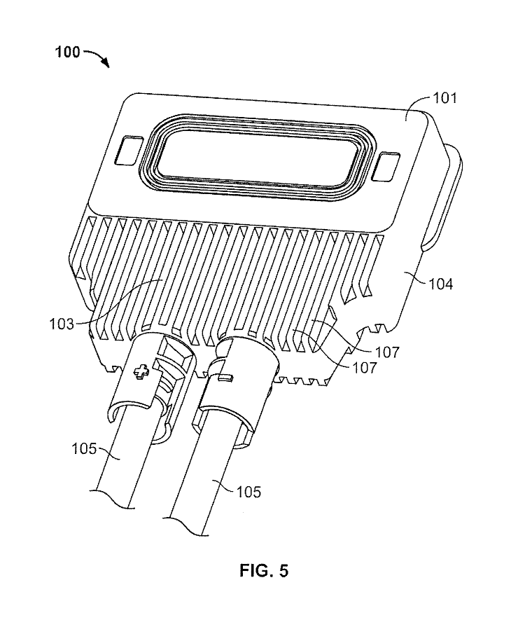

FIG. 4 shows a cutaway sectional view of the junction box 100 show and described above with respect to FIG. 3 with the cover portion 102 installed. The PCB 201 includes heat emitting electrical device 205 mounted to PCB 201 and contacts 203 by wire connections 209. The heat emitting electrical device 205 is in contact with heat sink 207. The heat sink 207, heat emitting electrical device 205 and a portion of PCB 201 is overmolded by thermally conductive material forming fin 107. The fin 107 is further encased with a secondary heat sink 303. The secondary heat sink 303 may be constructed of copper, aluminum, or other thermally conductive material. The secondary fins 301 are attached to the heat dissipating portion 103 of the junction box 100 on the secondary heat sink 303. Secondary fins 301 may be fabricated from any suitable thermally conductive material including, but not limited to, copper, aluminum, polymer, or other thermally conductive material.

FIG. 5 shows another embodiment of the present invention, including a box portion 101 and a heat dissipating portion 103, wherein the components are fabricated as a unitary construction. In addition, the box portion 101 and heat dissipating portion 103 may be fabricated separately and joined together in any conventional manner. The PCB 201, contacts 203, heat emitting electrical devices 205, wire connections 209, fins 107, case 104 and leads 105 are configured substantially as shown and described with respect to FIGS. 1 and 2, above. However, FIG. 5 includes fins 107 fabricated as a polymeric overmolding of the PCB 201 during fabrication of the case 104. In this embodiment of the invention, the fins 107 may be incorporated in case 104 to provide a thermally conductive case 104 having fins 107, which more efficiently dissipate heat to the environment.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A junction box for interconnection of solar cell arrays in a power distribution system, the junction box comprising:
a box portion, heat dissipating portion and a printed circuit board (PCB);
the PCB includes at least one heat emitting electrical component, each heat emitting electrical component having a heat sink element attached thereto for dissipating heat generated by the heat emitting electrical component, and at least one electrical contact electrically connected to the at least one heat emitting electrical component;
the box portion is configured for receiving at least a portion of the PCB, the box portion including a first opening for receiving a cover portion, and a second opening disposed opposite the first opening for receiving external power input wiring by electrical contact with the at least one electrical contact; and
the heat dissipating portion comprising a thermally conductive material covering at least a portion of the heat sink, the thermally conductive material further comprising a surface area that is capable of dissipating heat.

2. The junction box of claim 1, wherein the at least one heat emitting electrical component is a diode.

3. The junction box of claim 1, wherein the at least one heat emitting electrical component is a plurality of diode elements being TO-220 packaged diodes, wherein the TO-220 packaged diodes further comprising heat sink tabs for dissipating heat.

4. The junction box of claim 1, wherein the at least one heat emitting electrical component is a plurality of diode elements being ITO-220AC diodes, wherein the ITO-220AC diodes having plastic covered heat sinks to dissipate heat at a rate sufficient to meet the requirements of IEC 61215.

5. The junction box of claim 1, wherein the heat sink elements extend from the box portion into the heat dissipating portion, such that the heat sinks transfer thermal energy from the heat emitting electrical components to the heat dissipating portion, and the heat dissipating portion dissipating the heat externally of the junction box.

6. The junction box of claim 1, wherein the box portion and the heat dissipating portion both comprise the thermally conductive material.

7. The junction box of claim 1, wherein the thermally conductive material is a non-electrically conductive polymeric material.

8. The junction box of claim 1, wherein the box portion is constructed of a substantially rigid, electrically insulating and thermally conductive material.

9. The junction box of claim 8, wherein the material is an ABS plastic.

10. The junction box of claim 1, wherein the electrical contacts are secured to the PCB with a solder connection to receive the external power input wiring.

11. The junction box of claim 1, wherein the PCB includes at least two contacts.

12. The junction box of claim 1, wherein the PCB includes at least four contacts.

13. The junction box of claim 1, wherein the heat dissipating portion further comprises a secondary heat sink disposed on a surface of the thermally conductive material.

14. The junction box of claim 13, further comprising a secondary fin disposed on the secondary heat sink.

15. An interconnection system for solar cell arrays in a power distribution system, the system comprising:
at least one electrical current providing device; and
a junction box connecting a plurality of the current producing devices, the junction box comprising:
a box portion, heat dissipating portion and a printed circuit board (PCB);
the PCB includes at least one heat emitting electrical component, each heat emitting electrical component having a heat sink element attached thereto for dissipating heat generated by the heat emitting electrical component; and at least one electrical contact electrically connected to the at least one heat emitting electrical component;
the box portion is configured for receiving at least a portion of the PCB, the box portion including a first opening for receiving a cover portion, and a second opening disposed opposite the first opening for receiving wiring from the at least one current providing device by electrical contact with the at least one electrical contact; and
the heat dissipating portion comprising a thermally conductive material covering at least a portion of the heat sink, the thermally conductive material further comprising a surface area that is capable of dissipating heat.

16. The system of claim 15, wherein the at least one current providing device is a photovoltaic cell.

17. The system of claim 15, wherein the at least one current providing device is a photovoltaic array.

18. The system of claim 15, wherein the heat sink elements extend from the box portion into the at least one heat dissipating portion, such that the heat sinks transfer heat from the heat emitting electrical components to the at least one heat dissipating portion, and the at least one heat dissipating portion dissipating the heat externally of the junction box.

19. The system of claim 15, wherein the at least one heat dissipating portion further comprises a secondary heat sink disposed on a surface of the thermally conductive material.

20. The system of claim 15, further comprising a secondary fin disposed on the secondary heat sink.
